(19) United States
(12) Patent Application Publication
(10) Pub. No.: US 2009/0210719 A1
(43) Pub. Date: Aug. 20, 2009

(54) COMMUNICATION CONTROL METHOD OF DETERMINING WHETHER COMMUNICATION IS PERMITTED/NOT PERMITTED, AND COMPUTER-READABLE RECORDING MEDIUM RECORDING COMMUNICATION CONTROL PROGRAM

(75) Inventor: Hiroki Yoshida, Takatsuki-shi (JP)

Correspondence Address: SIDLEY AUSTIN LLP, 717 NORTH HARWOOD, SUITE 3400, DALLAS, TX, 75201, US

(73) Assignee: Konica Minolta Holdings, Inc., Tokyo (JP)

(21) Appl. No.: 12/201,196

(22) Filed: Aug. 29, 2008

(30) Foreign Application Priority Data
Feb. 19, 2008 (JP) 2008-037330

(51) Int. Cl. H04L 9/32; H04L 9/00

(52) U.S. Cl. 713/179; 726/6; 713/176

(57) ABSTRACT

In a first information processing device, a specific part of a binary code of a first application program developed in a first memory and a specific function are used to calculate a first identification value. The first identification value is transmitted from the first information processing device to a second information processing device. In the second information processing device, a specific part of a binary code of a second application program developed in a second memory and a specific function are used to calculate a second identification value, and the first identification value received from the first information processing device is compared with the second identification value. If these identification values are identical, connection with the first information processing device is permitted in the second information processing device.

This application is based on Japanese Patent Application No. 2008-037330 filed with the Japan Patent Office on Feb. 19, 2008, the entire content of which is hereby incorporated by reference.

### BACKGROUND OF THE INVENTION

1. Field of the Invention

The present invention relates to communication control, and particularly to a communication control method of determining whether communication with a communication target terminal is permitted/not permitted and a computer-readable recording medium recording a communication control program.

2. Description of the Related Art

Generally, when a user has an application program executed in a terminal so as to establish communication with another terminal in which another application program is executed, communication between the application programs is desirably secure. This is because, if the application program of a communication target (another application program above) is illegally tampered or if the application program is a malevolent program with which connection is not compensated for, information leakage from the terminal used by the user may occur.

Document 1 (Japanese Laid-Open Patent Publication No. 2005-293504) and Document 2 (Japanese Laid-Open Patent Publication No. 2006-203564) disclose a method of verifying authenticity of an application program executed in a client terminal.

Document 1 discloses a technique to check authenticity of an application program in a client device and transmit a result of checking to a server device when the server device checks authenticity of the application program started up in the client device. When authenticity of the application program is checked in the client device, hash data of the application program is generated by using a hash function, and the generated hash data is compared with data prepared in advance. When the data match with each other, the application program is determined as authentic.

Document 2 discloses a grid computing system in which a program sent from a server is executed by a node and the executed program and information on results including a result of execution of the program are sent back to the server. According to this system, when the node sends the information on results to the server, a hash value of the executed program is calculated and transmitted to the server. In the server, the hash value received from the node is compared with a hash value calculated from the program sent to the node (stored in the server), and based on matching of the hash values, it is verified that the program executed by the node has not been tampered.

According to the conventional technique as disclosed in Document 1 above, however, authenticity of the application program started up by the client terminal itself is verified and verification data indicating the result is transmitted to the server. Here, it is authenticity of the entire application program that is verified. Namely, the hash value of the entire program is calculated and used for verification of authenticity.

In addition, according to the conventional technique disclosed in Document 2, at the time point when a program is distributed from the server to a plurality of nodes and each node completes execution of the corresponding program in the grid computer system, a digital signature is attached to the program for which a hash function has been operated and to the result of execution of the program, by using a secret key of each node. Here again, it is authenticity of the entire application program that is verified. Namely, the hash value of the entire program is calculated and used for verification of authenticity.

Moreover, as described in Document 1 and Document 2 above, conventionally, the hash value of the (entire) program itself has been calculated to verify authenticity of the program. Therefore, even though an unauthorized third party obtains the program, the program may be determined as authentic.

### SUMMARY OF THE INVENTION

The present invention was made in view of such circumstances, and an object of the present invention is to provide a communication control method and a communication control program capable of quickly and reliably authenticating an application program to be executed in different terminals.

In addition, another object of the present invention is to provide a communication control method and a communication control program capable of avoiding such a situation that an application program is determined as authentic in the event that an unauthorized third party obtains the program.

A communication control method according to the present invention is a method of controlling communication between a first information processing device and a second information processing device, and includes the steps of: developing a first application program in a first memory in the first information processing device; calculating a first identification value using a specific part of a binary code of the first application program developed in the first memory and a specific function in the first information processing device; transmitting the first identification value from the first information processing device to the second information processing device; developing a second application program in a second memory in the second information processing device; calculating a second identification value using a specific part of a binary code of the second application program developed in the second memory and the specific function in the second information processing device; and permitting connection with the first information processing device in the second information processing device when the first identification value received from the first information processing device and the second identification value are identical as a result of comparison of these identification values.

A computer-readable recording medium according to the present invention is a computer-readable recording medium storing a communication control program for controlling communication with another information processing device. The communication control program causes a computer to execute the steps of: calculating a first identification value using a specific part of a binary code of an application program developed on a memory in execution of the application program and a specific function; transmitting the first identification value to another information processing device; receiving a second identification value from another information processing device; and permitting connection with another information processing device when the first identification value and the second identification value are identical as a result of comparison of these identification values.

According to the present invention, in information processing devices each executing an application program, the application program is authenticated based on a specific part of a binary code obtained when the application program is developed on a memory, and therefore, the application program of a target information terminal device can quickly and reliably be authenticated.

In addition, according to the present invention, as an application program is authenticated based on a specific part of a binary code developed on a memory, even though a third party obtains the application program itself, the third party cannot easily know which part is used for authentication. Therefore, authentication can more securely be carried out.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically showing a network configuration including an information processing device in a first embodiment of the present invention.

FIG. 2 is a diagram schematically showing a functional block of a PC (personal computer) in FIG. 1.

FIG. 3 is a control block diagram of the PC in FIG. 1.

FIG. 4 illustrates a procedure for generating data in order to have a communication target terminal authenticate an application program, in the PC in FIG. 1.

FIGS. 5A and 5B illustrate a configuration necessary for authenticating an application program being executed in a communication target terminal in the PC in FIG. 1.

FIG. 6 illustrates a flow of data when an application program being executed in a communication target terminal is authenticated in the PC in FIG. 1.

FIG. 7 is a flowchart showing processing when a terminal in which an application (2) (an exemplary application program) has been started up requests permission of connection to a terminal in which an application (1) (an exemplary application program) has been installed, in the present embodiment.

FIG. 8 is a flowchart showing a sub routine for generating an encrypted identification value in FIG. 7.

FIG. 9 is a flowchart showing processing when the terminal in which application (2) has been started up requests permission of connection to the terminal in which application (1) has been installed, in a second embodiment of the present invention.

FIG. 10 is a flowchart showing a sub routine for generating an encrypted identification value in a third embodiment of the present invention, corresponding to a variation of FIG. 8.

### DESCRIPTION OF THE PREFERRED EMBODIMENTS

An information processing device according to one embodiment of the present invention will be described hereinafter with reference to the drawings.

### First Embodiment

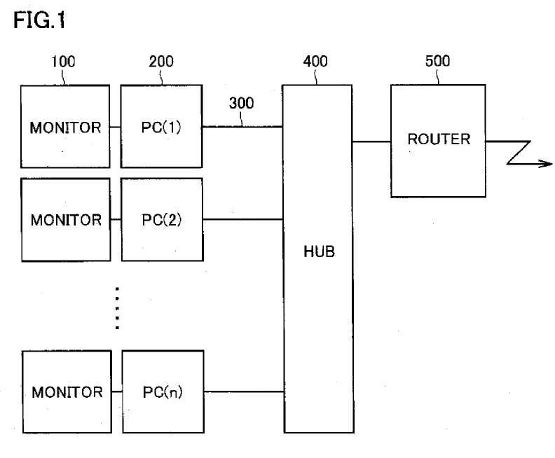

FIG. 1 is a diagram schematically showing a network configuration including an information processing device in the present embodiment.

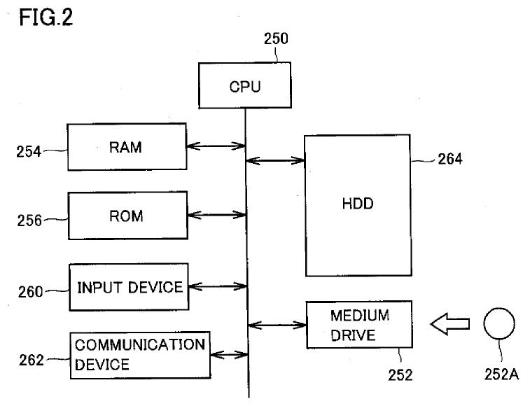

Referring to FIG. 1, the network includes a plurality of PCs representing one embodiment of a communication control device. In FIG. 1, each PC 200 is shown as PC (1) to PC (n). Each PC 200 is connected to a hub 400 through a network cable 300. Each PC 200 is configured such that it can be connected to a terminal connected to a not-shown another network, through hub 400 and a router 500. FIG. 2 is a diagram schematically showing a hardware configuration of PC 200. In addition, each PC 200 is connected to a monitor 100 for displaying a result of information processing or the like in PC 200.

Referring to FIG. 2, PC 200 includes a CPU (Central Processing Unit) 250 controlling an overall operation of PC 200, a RAM (Random Access Memory) 254 functioning as a work area of CPU 250, a ROM (Read Only Memory) 256 storing a program, data or the like, an input device 260 such as a keyboard for inputting information to PC 200, a communication device 262 communicating with another PC 200 or another network, a hard disk drive (HDD) 264 including a hard disk storing a program or a file, and a medium drive 252 accessing a storage medium 252A removable from PC 200. Namely, PC 200 can accept input of information input through input device 260, it can be connected to another terminal or network through communication device 262, and it can cause monitor 100 to display information processed in PC 200.

In addition, a file of a program to be executed by CPU 250 may be stored in ROM 256 or the hard disk of HDD 264, or stored in an external storage device accessed through communication device 262. Alternatively, the configuration may be such that a file stored in storage medium 252A through medium drive 252 or a file stored in the external storage device that can be accessed through communication device 262 is stored in the hard disk of HDD 264 and executed by CPU 250.

When CPU 250 executes the application program, for example, a program in a binary form and data used for an execution operation are developed in RAM 254 based on the application program stored in a non-volatile storage medium such as HDD 264. Such a program in a binary form (hereinafter, referred to as a “binary code”) developed in RAM 254 is what is called a native code that can directly be executed by CPU 250 depending on a hardware configuration of CPU 250.

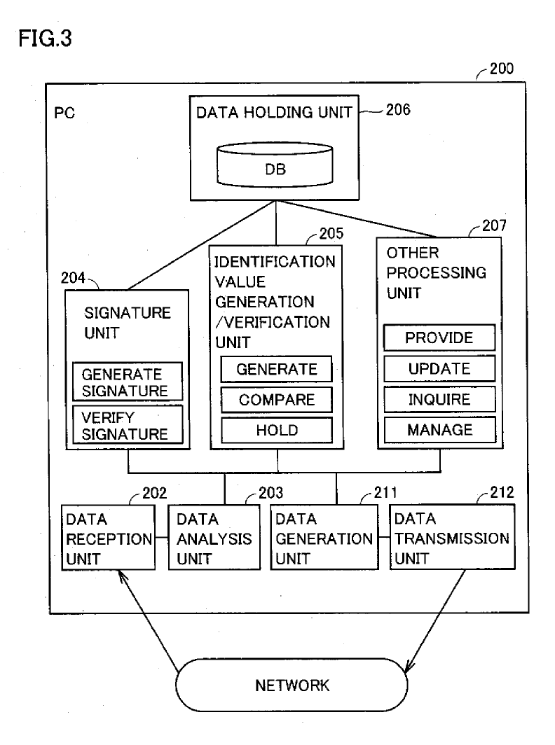

Referring to FIG. 3, a data reception unit 202 receives data transmitted to PC 200 through hub 400 (see FIG. 1). Data reception unit 202 determines whether the received data (packet) is a packet directed to the PC thereof or not, and when data reception unit 202 determines that the data is directed to the PC thereof, data reception unit 202 sends the data to a data analysis unit 203. Data analysis unit 203 extracts the data from the received packet, and if the extracted data contains a process command, data analysis unit 203 causes any of a signature unit 204, an identification value generation/verification unit 205, and a processing unit 207 to process the command.

Identification value generation/verification unit 205 extracts a part of the application program developed on RAM 254 and generates a specific identification value by combining that part with user information held in a data holding unit 206. Signature unit 204 generates an encrypted identification value by utilizing the specific identification value generated by identification value generation/verification unit 205. The generated specific identification value and the encrypted identification value are stored in data holding unit 206. The contents of these identification values and a method of generating the same will be described later.

When communication with a program being executed in another terminal connected through router 500 is started, identification value generation/verification unit 205 compares the specific identification value sent from the application being executed in another terminal with the encrypted identification value in a manner as will be described later. Then, based on a result of comparison, identification value generation/verification unit 205 determines whether connection with the application being executed in another terminal described above is to be permitted/refused.

In transmitting a message to another terminal, identification value generation/verification unit 205 generates data to be transmitted and sends the data to a data generation unit 211. Then, data generation unit 211 organizes the received data in a form of a network packet and sends the packet to a data transmission unit 212. Data transmission unit 212 transmits the packet to hub 400 such that the packet is sent to a destination determined by the data or the like received by data generation unit 211.

Hardware implementing the function of each functional block is not particularly limited in the block configuration shown in FIG. 3 above, however, for example, data holding unit 206 is implemented by RAM 254 and HDD 264. In addition, signature unit 204, identification value generation/verification unit 205, processing unit 207, data analysis unit 203, and data generation unit 211 are implemented by RAM 254 and CPU 250 executing the program stored in the hard disk of HDD 264. Data reception unit 202 and data transmission unit 212 are implemented by communication device 262. It is noted that data holding unit 206 may be provided with a storage device such as a flash memory, in addition to or instead of HDD 264, as a non-volatile storage device.

Other processing unit 207 attains functions other than those described above, such as processing for providing service specific to the application program (for example, processing for providing a word processor function if the application program is software for a word processor), processing for updating the application program online, or processing for inquiries as to whether or not updating is necessary or management of a version of the program.

Therefore, in an example shown in FIG. 3, though not particularly limited, it can be assumed that data analysis unit 203, signature unit 204, identification value generation/verification unit 205, and other processing unit 207 among the functional blocks are functions implemented by execution of the application program by CPU 250, and data analysis unit 203 and data generation unit 211 are functions implemented by execution of OS (Operating System) software by CPU 250.

In the present embodiment, in establishing communication between the application program being executed in PC 200 and the application program being executed in another terminal, connection is permitted on the condition that each application program authenticates the application program of the terminal on the other end.

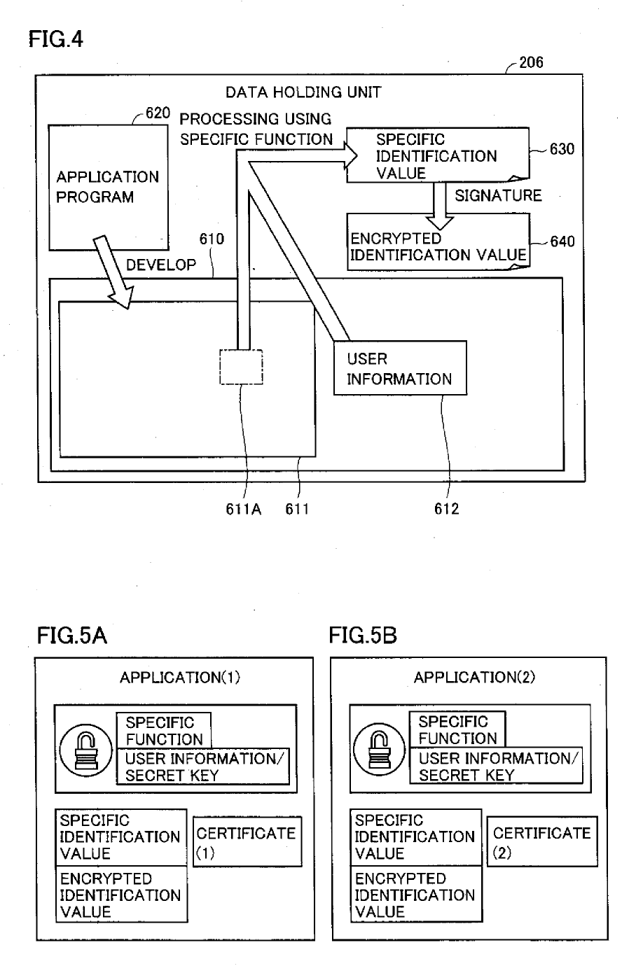

FIG. 4 is a diagram for illustrating a procedure for generating data for authentication, that is performed in PC 200 for authenticating the application program.

An application program 620 held in data holding unit 206 (such as HDD 264) is in a file form, and when the application program is started up in PC 200, the application program is developed in a form of the binary code in an area 611 of a main memory 610 implemented by RAM 254 or the like. A part 611A of the binary code of the developed application program is processed with a specific function (such as a hash function), to calculate a specific identification value 630. Part 611A of the binary code is located at a specific relative position within area 611 where the application program is developed. Namely, though an address of area 611 in main memory 610 may be different each time the application program is developed, part 611A of the binary code is specified, for example, by designating a certain range of address at a predetermined position from the starting address.

A part of which relative position is not moved when the application program is developed on the memory and in which data is not modified during use is employed as part 611A of the binary code. For example, a portion where a communication module is developed, a portion where original information (security data) of the application program is held, a portion where an encryption/decryption module is developed, a portion where version information is developed, and the like are suitable. Information for designating part 611A of the binary code is incorporated, for example, as security data of the application program, and recognized in advance in PCs 200 between which communication is established.

In the present embodiment, for improved security, part 611A of the binary code described above is combined with user information 612 (for example, these are simply arranged side by side) and processed with a specific function, to thereby calculate specific identification value 630. User information 612 is recognized by PCs 200 between which communication is established, and examples thereof are as follows.

1) Password for administrator . . . a password in a case where administrators of the PCs are identical

2) Network installation ID . . . a common installation ID in a case where the application programs of the PCs have been installed through a network

3) License information . . . license information common to the application programs of the PCs

4) Work group password . . . password common in a work group to which the PCs belong

In the present embodiment, a hash function is employed as the specific function, and specific identification value 630 is a hash value obtained as a result of operation with the hash function, of a value of part 611A of the binary code and user information 612 being combined, which is a value, for example, of 128 bits. The hash value is constant so long as the application program is not modified and user information 612 is not changed. Any function other than the hash function, of which output value is uniquely varied with variation in an input value, may be employed as the specific function.

In addition, in the present embodiment, an encrypted identification value 640 is produced by encrypting specific identification value 630 calculated as described previously. Encryption is carried out by attaching a signature to specific identification value 630 with a secret key corresponding to a public key included in an electronic certificate (such as X.509 certificate) held by each PC 200.

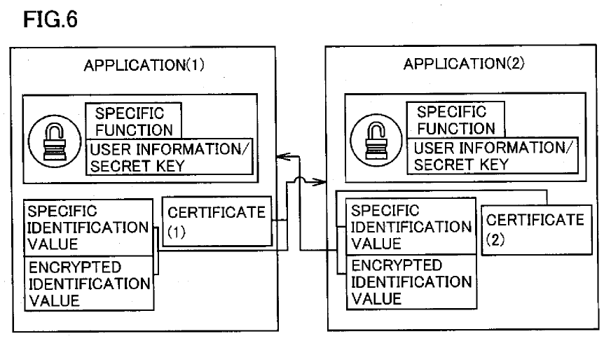

FIG. 6 illustrates a configuration of data for authentication necessary for authenticating the application program in PCs 200 between which communication is established. In the following, the application program executed in one PC 200 is referred to as an “application (1)” and the application program executed in the other PC 200 is referred to as an “application (2)”. The application program here may be firmware. For the sake of description, PC 200 itself executing each application program may be expressed as “application (1)” and “application (2)”.

FIG. 5A shows data for authentication held by PC 200 on application (1) side and FIG. 5B shows data for authentication held by PC 200 on application (2) side.

As shown in FIG. 5A, PC 200 on application (1) side holds the specific identification value and the encrypted identification value of application (1) as well as a certificate (1) of PC 200 itself. In addition, PC 200 holds the specific function, user information, a secret key, and the like, for example, in a secure area set in HDD 264 from which external reading is impossible. The specific function itself or a data table showing correspondence between an input and an output may be employed as the specific function. The secret key corresponds to the public key stored in certificate (1).

On the other hand, as shown in FIG. 5B, PC 200 on application (2) side also holds the specific identification value and the encrypted identification value of application (2) as well as a certificate (2) of PC 200 itself. In addition, PC 200 holds the specific function, the user information, a secret key, and the like, for example, in a secure area set in HDD 264 from which external reading is impossible. The secret key corresponds to the public key stored in certificate (2).

Referring to FIG. 6, when information requesting communication with application (2) is input to application (1), application (1) sends its certificate (certificate (1)) to application (2), and sends the specific identification value calculated as above and the encrypted identification value to application (2). In addition, when information requesting communication with application (1) is input to application (2), similarly, application (2) sends its certificate (2) as well as the specific identification value and the encrypted identification value to application (1). When the certificate as well as the specific identification value and the encrypted identification value are received from one of application (1) and application (2), the other of application (1) and application (2) sends back its certificate as well as the specific identification value and the encrypted identification value.

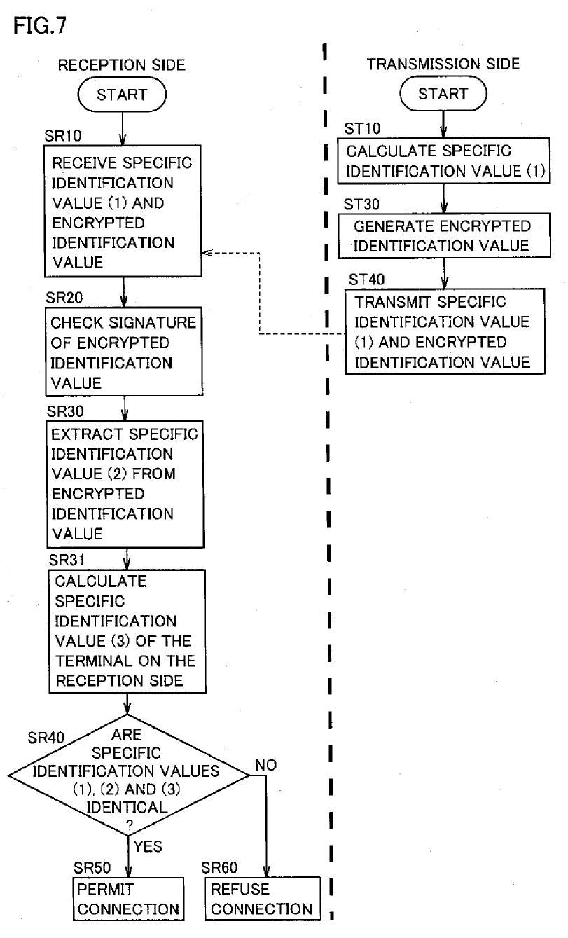

FIG. 7 is a flowchart showing processing when a terminal (such as PC 200) in which application (2) has been started up requests permission of connection to a terminal (such as PC 200) in which application (1) has been installed, in the present embodiment. In FIG. 7, the terminal requesting permission of connection is denoted as “transmission side”, while the terminal determining whether connection is permitted/not permitted is denoted as “reception” side.

Referring to FIG. 7, in the terminal on the transmission side, the specific identification value is calculated (step ST10) at the time point when application (2) is started up or the time point when information indicating a request of connection to the terminal on the reception side is input from the outside (for example, through input device 260).

The specific identification value thus calculated is hereinafter referred to as a “specific identification value (1)”. Then, in step ST30, the encrypted identification value is generated and stored in a memory such as RAM 254. Then, in step ST40, specific identification value (1) and the encrypted identification value are transmitted to the terminal on the reception side. In addition, certificate (2) on application (2) side is also transmitted to the terminal on the reception side.

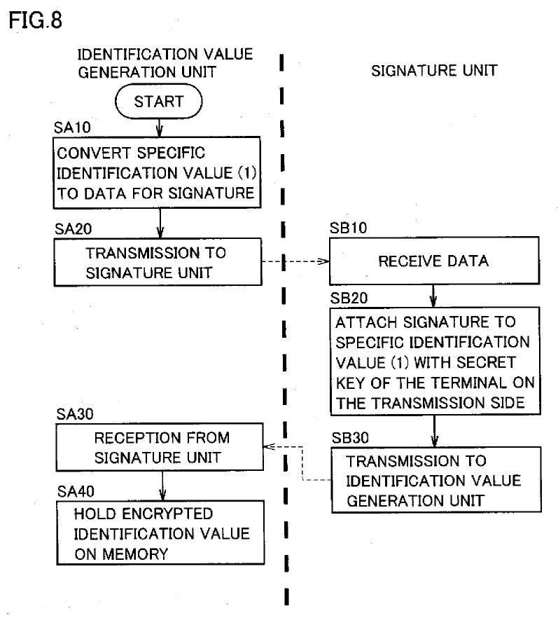

Here, generation of the encrypted identification value in step ST30 will be described with reference to FIG. 8 showing a flowchart of a sub routine of that processing.

FIG. 8 shows the processing content in identification value generation/verification unit 205 and signature unit 204.

Initially, in step SA10, identification value generation/verification unit 205 converts specific identification value (1) generated in step ST10 to data for signature, and the process proceeds to step SA20.

Thereafter, in step SA20, identification value generation/verification unit 205 transmits the data resultant in step SA10 to signature unit 204.

Then, in step SB10, signature unit 204 receives the data transmitted from identification value generation/verification unit 205, and in step SB20, signature unit 204 attaches the signature to received specific identification value (1) with the secret key of a machine thereof (of PC 200 on the transmission side). Then, the process proceeds to step SB30.

In step SB30, signature unit 204 transmits the data with signature (encrypted identification value) to identification value generation/verification unit 205.

In step SA30, identification value generation/verification unit 205 receives the encrypted identification value transmitted from signature unit 204, and thereafter in step SA40, the encrypted identification value is stored as appropriate in the memory. Then, the process returns to FIG. 7. Though the encrypted identification value may be stored as a file in a non-volatile storage device, it is erased simultaneously with the end of the application program. In addition, the encrypted identification value can be held in an area from which external reading is impossible (secure area) in the non-volatile storage device such as HDD 264, as in the case of the specific function.

Referring again to FIG. 7, when specific identification value (1) and the encrypted identification value are transmitted from the terminal on the transmission side to the terminal on the reception side in step ST40, the terminal on the reception side receives specific identification value (1) and the encrypted identification value in step SR10. In step SR20, the terminal on the reception side extracts the public key of application (2) from the received certificate (certificate (2)) and decrypts (verifies) the encrypted identification value with the public key. Then, the process proceeds to step SR30.

In step SR30, the specific identification value (decrypted specific identification value) that is considered as data before encryption of the encrypted identification value transmitted from application (2) is extracted. The specific identification value extracted here is hereinafter referred to as a “specific identification value (2)”.

Then, in step SR31, the terminal on the reception side calculates the specific identification value. The specific identification value calculated here is hereinafter referred to as a “specific identification value (3)”.

Thereafter, in step SR40, specific identification value (1), specific identification value (2), and specific identification value (3) are compared with one another. When all of these are identical, the process proceeds to step SR50. When it is determined that they are not identical, the process proceeds to step SR60.

In step SR50, communication with application (2) is permitted in application (1), and subsequent processing for communication is performed.

On the other hand, in step SR60, processing for refusing communication with application (2) is performed.

Information that should be held as common information in the PC on application (1) side and the PC on application (2) side in the present embodiment is listed as follows.

Specific function (hash function)

Information on which part of the application program is to be input to the specific function (hash function) (The information represents a relative range of address on a memory when the application program is developed on the memory; a part of which value does not vary in spite of execution of the application program is suitable as the “part” here; specifically, examples thereof include a communication module portion, an application program original information (security data) holding portion/developing portion, an encoding/decoding module developing portion, a version information developing portion, and the like.)

User information (it is noted that user information is not essential for calculating the specific identification value)

Other information (information necessary for authenticating a public key, such as a secret key generated for a user of each PC, a public key (certificate) of a target PC, and a route certificate of CA)

In addition, in the present embodiment described above, as to the user information, specific identification value (1), specific identification value (2), and specific identification value (3) are compared with one another in step SR40, and connection is not permitted unless all of these are identical. The present invention, however, is not necessarily configured as such.

Namely, the network in the present embodiment can be configured such that any of specific identification value (1) and the encrypted identification value should only be transmitted from the terminal on the transmission side to the terminal on the reception side. Where specific identification value (1) is transmitted, when it is determined in step SR40 that specific identification value (1) is identical to specific identification value (3), connection is permitted in the terminal on the reception side. In such a case, it is not necessary to calculate the encrypted identification value in the terminal on the transmission side (step ST30) or to extract specific identification value (2) in the terminal on the reception side (step SR30), so that the determination processing in the terminal on the reception side (step SR40) can be simplified.

On the other hand, where the encrypted identification value is transmitted, when it is determined in step SR40 that specific identification value (2) is identical to specific identification value (3), connection is permitted in the terminal on the reception side. In such a case as well, the determination processing in the terminal on the reception side (step SR40) can be simplified.

In the description of the first embodiment above, application (1) and application (2) may store the “route certificate” issued by an authentication authority or the like, and application (1) or application (2) may obtain the signature from the authentication authority (authentication server) for its own certificate (1) or certificate (2), and send its own certificate together with the signature of the authentication authority in transmission to the other side. By doing so, the application program on the reception side or the transmission side can check that the application program on the other side has the certificate issued by the authentication authority or by an official organization comparable to that, and reliability of the certificate can be improved.

### Second Embodiment

In the first embodiment described above, when the terminal in which application (2) has been started up requests connection to the terminal in which application (1) has been installed, the terminal on the transmission side generates the specific identification value and the encrypted identification value each time they are transmitted to the terminal on the reception side, as described with reference to FIG. 7.

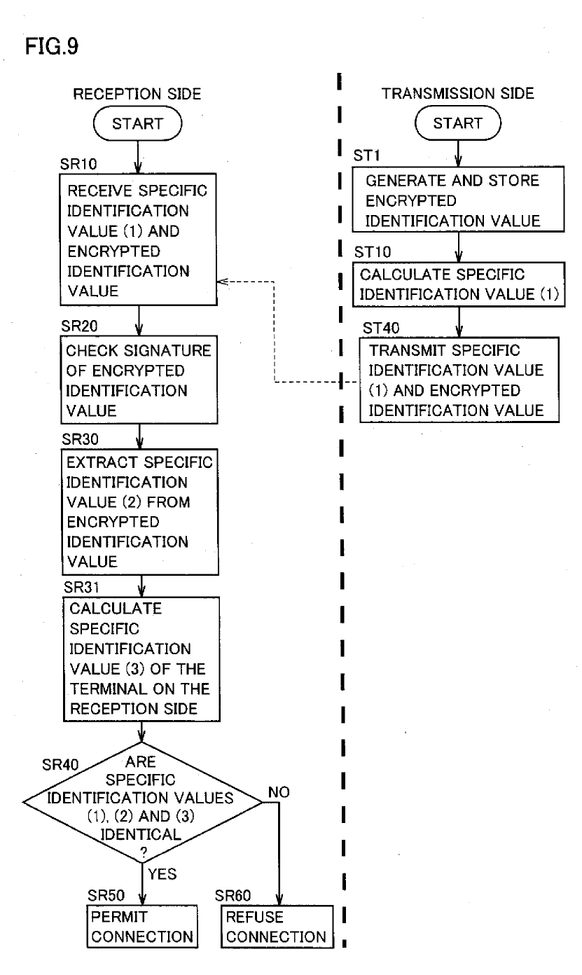

On the other hand, in the present embodiment, as shown in FIG. 9, the terminal on the transmission side generates the specific identification value and the encrypted identification value based thereon at specific timing (for example, at the time of installation or upgrading of application (2)) and stores the same (step ST1).

Then, receiving a request or the like for transmission of the encrypted identification value and the specific identification value from the terminal on the reception side, the terminal on the transmission side calculates specific identification value (1) in step ST10, and transmits specific identification value (1) calculated in step ST10 and the encrypted identification value stored in step ST1 to the terminal on the reception side in step ST40.

The terminal on the reception side extracts specific identification value (2) from the encrypted identification value received from the terminal on the transmission side (step SR30). As described with reference to FIG. 7, in the present embodiment as well, connection with the terminal on the transmission side is refused unless all of specific identification value (1), specific identification value (2) and specific identification value (3) are identical. Namely, if specific identification value (1) is not identical to specific identification value (2), the terminal on the reception side refuses connection with the terminal on the transmission side.

Therefore, in the present embodiment, if application (1) is modified between generation of the encrypted identification value and calculation of specific identification value (1) in the terminal on the transmission side, specific identification value (1) is no longer identical to specific identification value (2). In such a case, in the present embodiment, as determination as NO is made in step SR40, the terminal on the reception side can refuse connection with the terminal on the transmission side.

### Third Embodiment

The third embodiment of the present invention is different from the first embodiment in a manner of generating the encrypted identification value in application (2) representing the terminal on the transmission side.

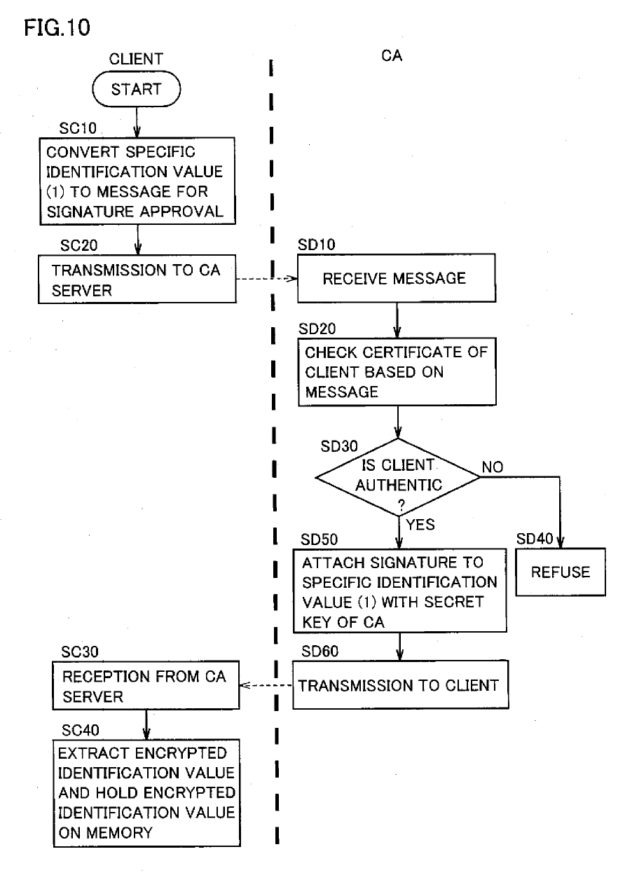

FIG. 10 is a flowchart in an example where the encrypted identification value is generated in the terminal on the transmission side (application (2)) in the present embodiment. The flowchart corresponds to a variation of the sub routine of step ST30 in FIG. 7. In addition, in the present embodiment, with regard to production of the encrypted identification value, data transmission and reception is carried out between the terminal (client) in which application (2) has been installed and an authentication server (CA (Certification Authority) server).

Referring to FIG. 10, when application (2) is started up in the client, specific identification value (1) generated in step ST10 (see FIG. 7) is converted to data for signature approval in step SC10, and the process proceeds to step SC20.

Then, in step SC20, the client transmits data resultant in step SC10 to the CA server.

Thereafter, in step SD10, the CA server receives the data transmitted from the client, and in step SD20, the certificate is extracted from the received data. Then, the process proceeds to step SD30.

Then, in step SD30, the CA server determines whether the client is authentic or not based on the certificate extracted in step SD20. When it is determined that the client is authentic, the process proceeds to step SD50. When it is determined that the client is not authentic, the process proceeds to step SD40.

In step SD50, the CA server extracts specific identification value (1) from the data received in step SD10 and attaches the signature to specific identification value (1) using the secret key held in the CA server. Then, the process proceeds to step SD60. In step SD60, the CA server transmits to the client, specific identification value (1) (encrypted identification value) with the signature.

On the other hand, in step SD40, the CA server notifies the client of refusal of the signature, and the process ends without the signature as in step SD50 being attached.

In step SC30, the client receives the encrypted identification value transmitted from the CA server, and thereafter in step SC40, the encrypted identification value is stored as appropriate in the memory as in step SA40. In this case as well, as in the first embodiment, the encrypted identification value may be stored as a file in a non-volatile storage device, however, it is erased simultaneously with the end of the application program. In addition, the encrypted identification value can be held in an area from which external reading is impossible (secure area) in the non-volatile storage device such as HDD 264, as in the case of the specific function or the certificate received from the other terminal.

As described above, in the present embodiment, the signature is attached to the encrypted identification value (encryption) by using the secret key of the CA server. Accordingly, the public key used in step SR20 (see FIG. 7) where the signature of the encrypted identification value is checked and in step SR30 (see FIG. 7) where specific identification value (2) is extracted from the encrypted identification value in the terminal on the reception side (application (1)) is stored in the route certificate representing the certificate of the CA server.

According to the above configuration as well, an effect the same as in the first embodiment can be obtained.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method of controlling communication between a first information processing device and a second information processing device, comprising the steps of:
developing a first application program in a first memory in said first information processing device;
calculating a first identification value using a specific part of a binary code of said first application program developed in said first memory and a specific function in said first information processing device;
transmitting said first identification value from said first information processing device to said second information processing device;
developing a second application program in a second memory in said second information processing device;
calculating a second identification value using a specific part of a binary code of said second application program developed in said second memory and said specific function in said second information processing device; and
permitting connection with said first information processing device in said second information processing device when said first identification value received from said first information processing device and said second identification value are identical as a result of comparison of these identification values.

2. The method according to claim 1, wherein
said first information processing device encrypts said first identification value and transmits encrypted said first identification value to said second information processing device, and
said second information processing device decrypts said encrypted first identification value and thereafter compares decrypted said first identification value with said second identification value.

3. The method according to claim 2, wherein
said first information processing device transmits both of said encrypted first identification value and not-encrypted said first identification value to said second information processing device, and
said second information processing device decrypts said encrypted first identification value, thereafter compares the decrypted first identification value with said not-encrypted first identification value, and determines whether these identification values are identical.

4. The method according to claim 3, wherein
said first information processing device encrypts said first identification value and holds encrypted said first identification value in a storage device, calculates said first identification value each time communication with said second information processing device is established, and transmits to said second information processing device, both of said encrypted first identification value held in said storage device and newly calculated said first identification value.

5. The method according to claim 2, wherein
said first information processing device transmits said first identification value to an authentication server for encryption and receives encrypted said first identification value from said authentication server.

6. The method according to claim 1, wherein
said first information processing device further uses user information in calculating said first identification value, and
said second information processing device further uses said user information in calculating said second identification value.

7. The method according to claim 1, wherein
said specific function is a hash function.

8. A computer-readable recording medium storing a communication control program for controlling communication with another information processing device, said communication control program causing a computer to execute the steps of:
calculating a first identification value using a specific part of a binary code of an application program developed on a memory in execution of the application program and a specific function;
transmitting said first identification value to another information processing device;
receiving a second identification value from said another information processing device; and
permitting connection with said another information processing device when said first identification value and said second identification value are identical as a result of comparison of these identification values.

9. The computer-readable recording medium according to claim 8, wherein said first identification value is encrypted before it is transmitted to said another information processing device.

10. The computer-readable recording medium according to claim 9, wherein
both of encrypted said first identification value and not-encrypted said first identification value are transmitted to said another information processing device.

11. The computer-readable recording medium according to claim 10, wherein
said encrypted first identification value is encrypted at prescribed timing and held in a storage device.

12. The computer-readable recording medium according to claim 8, wherein
user information is further used in calculating said first identification value.

13. The computer-readable recording medium according to claim 8, wherein
said specific function is a hash function.
